(19) United States
(12) Patent Application Publication
(10) Pub. No.: US 2013/0117477 A1
(43) Pub. Date: May 9, 2013

(54) WIRELESS SIGNAL TRANSMITTING/RECEIVING APPARATUS FOR SEMICONDUCTOR SYSTEM

(71) Applicants: Yang Hee KIM, Icheon (KR); Ic Su Oh, Icheon (KR); Jun Ho Lee, Icheon (KR); Hyun Seok Kim, Icheon (KR); Boo Ho Jung, Icheon (KR); Sun Ki Cho, Icheon (KR)

(72) Inventors: Yang Hee KIM, Icheon (KR); Ic Su Oh, Icheon (KR); Jun Ho Lee, Icheon (KR); Hyun Seok Kim, Icheon (KR); Boo Ho Jung, Icheon (KR); Sun Ki Cho, Icheon (KR)

(73) Assignee: SK hynix, Inc., Icheon (KR)

(21) Appl. No.: 13/524,518

(22) Filed: Jun. 15, 2012

(30) Foreign Application Priority Data
Nov. 4, 2011 (KR) 10-2011-0114427

(51) Int. Cl. G06F 13/12

(52) U.S. Cl. 710/71

(57) ABSTRACT

A wireless signal transmitting/receiving apparatus for a semiconductor system is disclosed The apparatus includes a serializer/deserializer (SERDES) circuit and a coupling pad. The SERDES circuit outputs a parallel input signal as a serial signal during transmission, and outputs a serial input signal as a parallel signal during reception. The coupling pad generates an inductively coupled wireless signal according to the serial signal outputted from the SERDES circuit, and provides a signal generated by inductive coupling with an external device as the serial input signal of the SERDES circuit.

### CROSS-REFERENCES TO RELATED APPLICATION

The present application claims priority under 35 U.S.C. §119(a) to Korean application number 10-2011-0114427, filed on Nov. 4, 2011, in the Korean Intellectual Property Office, which is incorporated herein by reference in its entirety.

### BACKGROUND

1. Technical Field

Embodiments of the present invention relate to a semiconductor system, and more particularly, to a wireless signal transmitting/receiving apparatus for a semiconductor system.

2. Related Art

A semiconductor device may be implemented on a single Integrated Circuit chip. Inductive coupling can be used for communication between on-chip semiconductor devices of different chips. Further, a data exchange between a semiconductor device to be tested and test equipment which can be performed in a wafer-level test, can be performed using inductive coupling.

FIG. 1 illustrates an arrangement of a signal transmission pads 12 provided to a general semiconductor device 10. As illustrated in FIG. 1, the semiconductor device 10 has a plurality of pads 14-1 through 14-m including pads S for control signal transmission/reception, power supply pads P, address input pads A0 to A11, data input/output pad D0 to D15, and the like.

Each of the pads 14 can be implemented as an inductor so as to perform communication between on-chip semiconductor devices 10 or be utilized in data exchanges using the inductive coupling in a test mode. However, the size of each signal transmission pad 14 provided to the on-chip semiconductor device 10 is minimized suitable for the reduction ratio of a chip size. Therefore, the size of the pad 14 cannot be formed sufficiently large enough in area to insure that inductive coupling is induced while adhering to the size requirements imposed on the chip areas. Accordingly, the intensity of a transmitted/received signal is decreased. Further, the already low intensity signal may be offset or may be attenuated by noise generated during signal transmission/reception. Therefore, a reception stage that receives the signal has difficulty in precisely detecting a signal transmitted from a transmission stage.

In addition, an inductive coupling value is much smaller when the signal level is transmitted. As a result, data transmission/reception may be difficult if not impossible. A pad inductance of 4 nH or greater generally provides for stable coupling. Therefore, the size of pad 14 should be increased sufficiently so as to increase the inductance to a minimum of 4 nH. However, the inductance obtained through a process of a pad with an area of 60 μm*70 μm is practically 1 nH or less.

That is, since the area of a chip is limited, it is difficult to secure an inductance that supplies sufficient inductive coupling to allow for good wireless communications. Therefore, there is a need in both transmission and reception for semiconductor chips to increase the inductance of the coupling pads so as to obtain sufficiently high coupling efficiency when communicating between chips having identical or similar pad sizes.

### SUMMARY

In some embodiments of the present invention, a wireless signal transmitting/receiving apparatus for a semiconductor system includes a transmission control unit coupled to receive transmit data from a signal transmission line; a reception control unit coupled to provide received data to the signal transmission line; a serializer/deserializer (SERDES) circuit coupled to the transmission control unit and the reception control unit, the SERDES circuit serializing parallel data received from the transmission control unit and providing parallel data to the reception control unit; an input/output buffer coupled to receive signals from the SERDES circuit and to provide signals to the SERDES circuit, the input/output buffer converting between signals received and provided to the SERDES circuit and differential signals; a driver coupled to receive and provide differential signals to the input/output buffer; and a coupling pad configured to generate a wireless signal corresponding to the differential signals and to provide differential signals corresponding to wireless signals received to the driver.

In some embodiments of the present invention, a wireless signal transmitting/receiving apparatus for a semiconductor system includes a SERDES circuit configured to output a parallel input signal as a serial signal, and output a serial input signal as a parallel signal; and a coupling pad configured to generate inductance according to the serial signal outputted from the SERDES circuit, and provide a signal generated by inductive coupling with an external device as the serial input signal of the SERDES circuit.

In some embodiments of the present invention, a method of transmitting signals from a semiconductor signal includes serializing a plurality of parallel configured signals to form a serial signal; and coupling the serial signal to an inductive pad to wirelessly transmit the serial signal.

In some embodiments of the present invention, a method of receiving signals into a semiconductor signal includes receiving the wireless signal at an inductive pad to form a series signal; and converting the series signal to a plurality of parallel signals.

These and other embodiments are further described below with respect to the following figures.

### BRIEF DESCRIPTION OF THE DRAWINGS

Features, aspects, and embodiments are described in conjunction with the attached drawings, in which:

FIG. 1 shows a diagram illustrating an arrangement of a signal transmission pad provided to a general semiconductor device;

FIG. 2 illustrates a block diagram of a wireless signal transmitting/receiving apparatus for a semiconductor system according to some embodiments of the present invention;

FIG. 3 illustrates an exemplary block diagram of the serializer/deserializer (SERDES) circuit illustrated in FIG. 2;

FIG. 4 illustrates an exemplary diagram of a pulse generation unit illustrated in FIG. 3;

FIG. 5 shows a block diagram of the pulse generation unit illustrated in FIG. 4; and

FIG. 6 shows a timing diagram illustrating an operation of the pulse generation unit illustrated in FIG. 3.

In the figures, elements having the same designation have the same or similar function.

### DETAILED DESCRIPTION

Embodiments of a wireless signal transmitting/receiving apparatus for a semiconductor device will be described below with reference to the accompanying drawings through exemplary embodiments. In the following description specific details are set forth describing certain embodiments. It will be apparent, however, to one skilled in the art that the disclosed embodiments may be practiced without some or all of these specific details. The specific embodiments presented are meant to be illustrative, but not limiting. One skilled in the art may realize other material that, although not specifically described herein, is within the scope and spirit of this disclosure.

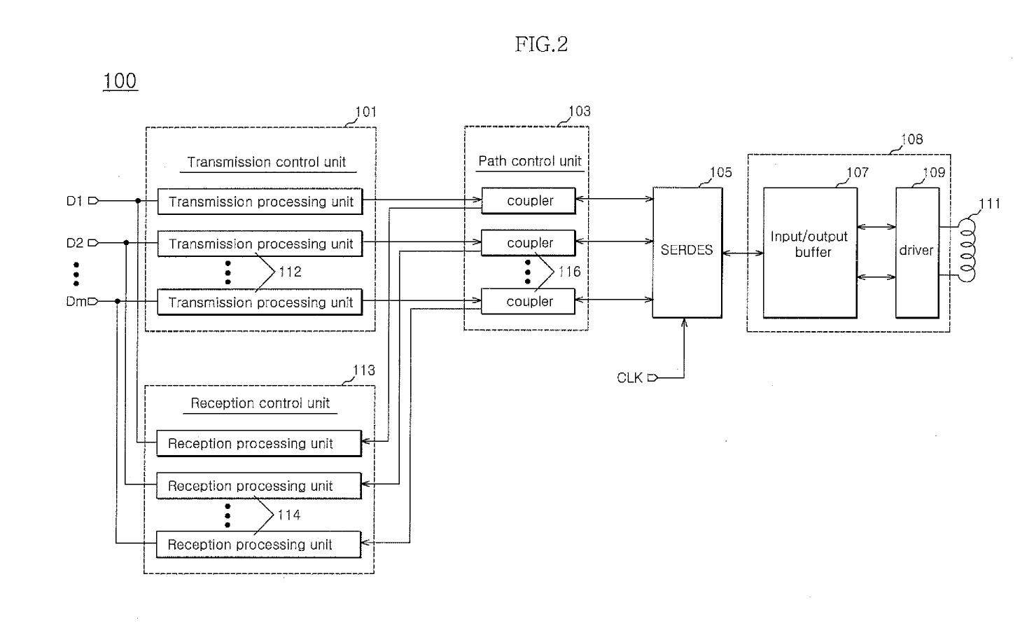

FIG. 2 is a block diagram of a wireless signal transmitting/receiving apparatus 100 for a semiconductor system according to some embodiments. As illustrated in FIG. 2, the wireless signal transmitting/receiving apparatus 100 includes a transmission control unit 101, a path control unit 103, a serializer/deserializer (SERDES) circuit 105, an input/output circuit 108, an inductive coupling pad 111 and a reception control unit 113. The input/output circuit 108 can be configured to include an input/output buffer 107 and a driver 109.

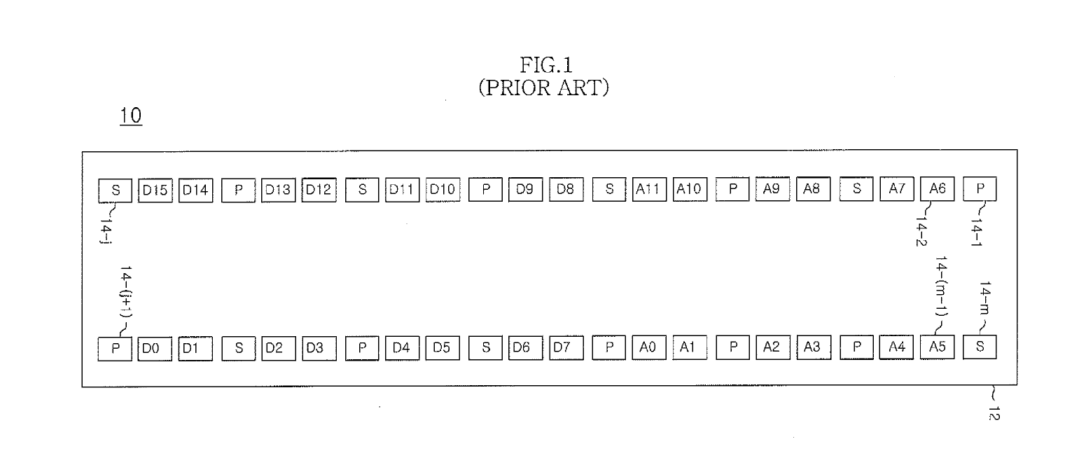

Data to be transmitted on inductive coupling pad 111 from signal transmission lines D1 to Dm is processed through transmission control unit 101, path control unit 103, is serialized in SERDES circuit 105, buffered in buffer 107, and transmitted by driver 109 coupled to inductive coupling pad 111. Conversely, data is received at inductive coupling pad 111 by driver 109, buffered in buffer 107, converted to parallel data in SERDES circuit 105, processed trough path control unit 103 and control unit 101 before being coupled at received data onto signal transmission lines D1 to Dm. Although FIG. 1 illustrates transmission lines D1 through Dm, embodiments of the invention can be utilized for transmission or reception of data on signal lines S, addresses on address lines A1 through A11, or other information as well.

Embodiments of transmitting/receiver apparatus 100 allow for larger area individual pads to provide for better inductive coupling while greatly reducing the large number of pads depicted in FIG. 1, allowing for a smaller area on the silicon chip that is utilized for inductive coupling.

The transmission control unit 101 includes a plurality (m) of transmission processors 112 for respectively receiving signals to be transmitted from a plurality (m) of signal transmission lines D1 to Dm and amplifying the received signals.

SERDES circuit 105 receives a signal inputted in parallel from the transmission control unit 101 through the path control unit 103, and serializes the inputted parallel signal in accordance with a clock signal CLK. SERDES circuit 105 then outputs the serial signal to input/output buffer 107.

The input/output circuit 108 separates the serial signal outputted from the SERDES circuit 105 into two signals. For this, the input/output circuit 108 can be configured to include an input/output buffer 107 separates the serial signal outputted from the SERDES circuit 105 into two signals, and the driver 109 amplifies the separated signals and then applies the amplified signals to the coupling pad 111. That is, AC current is necessarily applied to both terminals of the coupling pad 111 so that inductive coupling occurs in the coupling pad 111. Therefore, the serial signal is separated into two signals through the input/output buffer 107. In some embodiments, the input/output buffer 107 can be a single-to-differential buffer for generating a single input as a differential output signal.

Meanwhile, the signals received to the coupling pad 111 (e.g., differential signals as described above) are provided to the input/output buffer 107 through the driver 109, which provides a corresponding signal to SERDES circuit 105.

The SERDES circuit 105 parallelizes the inputted serial signal and outputs the corresponding parallel signal. The outputted parallel signal is provided to the reception processors 114 of the reception control unit 113 through the path control unit 103. The reception processors 114 of the reception control unit 113 amplifies the received signal and provides the amplified signal to each of the signal transmission lines D1 to Dm.

The path control unit 103 functions to transfer a signal outputted from the transmission control unit 101 to the SERDES circuit 105 in a signal transmission mode and to transfer a signal outputted from the SERDES circuit 105 to the reception control unit in a signal reception mode. In some embodiments, the path control unit 103 can be configured as a coupler, but the path control unit 103 is not limited thereto.

Although the wireless signal transmitting/receiving apparatus when transmission/reception paths are individually controlled by couplers 116 in path control unit 103 as has been illustrated in FIG. 2, embodiments of the present invention are not limited to this configuration. For example independent transmission and reception paths can be included. As such, a parallel/serial conversion unit, an output buffer and a transmission driver can be configured between the transmission control unit 101 and the coupling pad 111 on the transmission path, and a reception driver, an input buffer and a serial/parallel conversion unit can be configured between the coupling pad 111 and the reception unit 113 on the reception path. In this case, the coupling pad 111 is commonly used, and hence a path control unit can be additionally provided to a front end of the coupling pad.

An on-chip semiconductor has a plurality of signal transmission pads. In this embodiment, embodiments where parallel signals are serialized as one signal to be transmitted or where a serial signal is received and parallelized as m parallel signals to be outputted has been described. When the number of SERDES circuits 105 utilized is n, the number of pads for signal transmission or reception, i.e., the number of coupling pads 111 also becomes n.

That is, all the signal transmission pads are not implemented as inductors, but a plurality of pads are integrally implemented as one coupling pad 111. Thus, it is possible to implement a coupling pad 111 for generating sufficient inductance (e.g., by utilizing pads of sufficient area) in the limited area provided on the chip.

The integrally implemented coupling pad 111 can be an inductor, and signals separated by the input/output buffer 107 are respectively applied to both terminals of the inductor in signal transmission. A coupling signal is generated every data-level transfer period so as to be transmitted to a coupling pad of a reception stage.

As described above, in this embodiment, all the pads to the respective signal transmission lines are not implemented as coupling pads such as inductors, but a plurality of signal transmission lines is combined and then connected to One coupling pad. Accordingly, it is possible to increase inductance of the coupling pad while utilizing the same or less chip area as would be utilized in the system illustrated in FIG. 1.

In addition, in some embodiments inductive coupling at pad 111 can be greatly improved, and in some cases maximized. The coupling pad 111 generates a coupling signal when the data signal to be transmitted is transferred. If a short pulse is generated in the period when the level of the data is transferred, the value of the coupling signal can be increased.

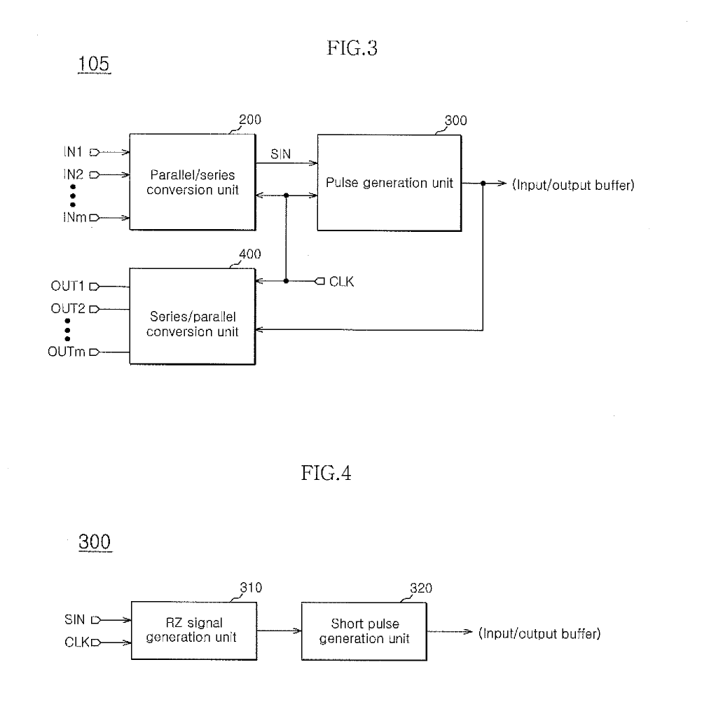

FIG. 3 is an exemplary diagram of the SERDES circuit illustrated in FIG. 2. As illustrated in FIG. 3, the SERDES circuit 105 includes a parallel/serial conversion unit 200, a pulse generation unit 300 and a serial/parallel conversion unit 400 so as to generate a short pulse in a data-level transfer period.

In a signal transmission path, signals IN1 to INm inputted to the SERDES circuit 105 through the path control unit 103 are converted into one serial signal SIN in the parallel/serial conversion unit 200. The serial signal SIN is provided to the pulse generation unit 300. The pulse generation unit 300 generates a short pulse from the serial signal SIN and provides the generated short pulse to the input/output buffer 107.

Generally, if a pulse shorter than the data-level transfer time of an input signal, e.g., a short pulse close to an impulse, is provided to an inductor, the inductive coupling will be greater than the actual data transfer and may easily occur even when the inductance of the inductor is small. Thus, in this embodiment, a serial signal to be transmitted is converted into a short pulse, and the converted short pulse is applied to the coupling pad 111, thereby improving coupling efficiency.

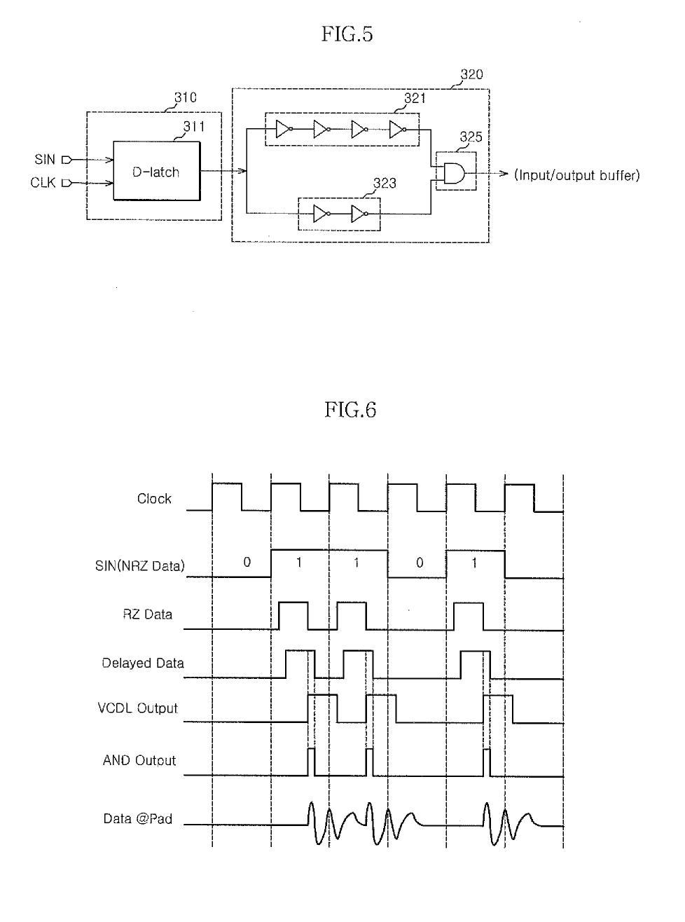

FIG. 4 is an exemplary diagram of the pulse generation unit 300 illustrated in FIG. 3. FIG. 5 is a configuration diagram of the pulse generation unit illustrated in FIG. 4.

As illustrated in FIG. 4, the pulse generation unit 300 includes a return-to-zero (RZ) signal generation unit 310 and a short pulse generation unit 320. The RZ signal generation unit 310 receives a serial signal SIN (not-return to zero (NRZ) Data) of which level is fixed, encodes the received serial signal SIN to a signal (RZ Data) of which level returns to a logic low state in response to a clock signal CLK, and then outputs the decoded return signal. The short pulse generation unit 320 converts the return signal outputted from the RZ signal generation unit 310 into a short pulse signal.

FIG. 5 illustrates an exemplary diagram of the RZ signal generation unit 310 and the short pulse generation unit 320. In this embodiment, the RZ signal generation unit 310 can be configured to include a D-latch 311. The short pulse generation unit 320 can be configured to include a fixed delay unit 321, a variable delay unit 323 and a pulse output unit 325.

A signal outputted through the D-latch 311 of the RZ signal generation unit 310 is delayed by a predetermined time in the fixed delay unit 321, and is delayed by a time according to the width of a pulse to be generated in the variable delay unit 323. The pulse output unit 325 outputs a signal of logic high level in the period when output signals of the fixed delay unit 321 and the variable delay unit 323 have high levels at the same time.

FIG. 6 is a timing diagram illustrating an operation of the pulse generation unit illustrated in FIG. 3. When the serial signal SIN (NRZ Data) is inputted, for example, in the order of 01101, the RZ signal generation unit 310 generates a 0 return signal (RZ Data), i.e., 0010100010.

The fixed delay unit 321 generates an output signal (Delayed Data) delayed by the predetermined time, and the variable delay unit 323 generates an output signal (VDCL Output) delayed by the width of the pulse to be generated. Thus, a short pulse (AND Output) is outputted in the period when the output signals of the pulse output unit 325, the fixed delay unit 321 and the variable delay unit 323 have high levels at the same time.

The signals are inputted to the coupling pad 111 through the input/output buffer 107 and the driver 109, and inductive coupling is generated with large inductance by the short pulse coupled to the coupling pad 111.

That is, when data are consecutively outputted from the parallel/serial conversion unit 200, the inductive coupling does not occur in the coupling pad 111 because no AC element exists in the period when data of logic low level is outputted. Therefore, the short pulse is generated only when the output data has a logic high level.

As described above, in this embodiment, data of logic high level is implemented as a short pulse, so that a high-frequency element can be increased by decreasing a level transfer period. Thus, the inductive coupling can be well induced even when the inductor has a relatively small inductance. Accordingly, although the size of the inductor constituting the signal transmission pad is not sufficiently secured, the inductive coupling can efficiently occur.

While certain embodiments have been described above, it will be understood to those skilled in the art that the embodiments described are by way of example only. Accordingly, the apparatus described herein should not be limited based on the described embodiments. Rather, the apparatus described herein should only be limited in light of the claims that follow when taken in conjunction with the above description and accompanying drawings.

What is claimed is:

1. A wireless signal transmitting/receiving apparatus for a semiconductor system, comprising:
a transmission control unit coupled to receive transmit data from a signal transmission line;
a reception control unit coupled to provide received data to the signal transmission line;
a serializer/deserializer (SERDES) circuit coupled to the transmission control unit and the reception control unit, the SERDES circuit serializing parallel data received from the transmission control unit and providing parallel data to the reception control unit;
an input/output circuit configured to separate and amplify the serializing parallel data to provide the serializing parallel data to a coupling pad, and provide a received signal from the coupling pad to the SERDES circuit; and
the coupling pad configured to generate a wireless signal corresponding to the separated and amplified signal and to provide signals corresponding to wireless signals received from an external device to the input/output circuit.

2. The apparatus according to claim 1, wherein the input/output circuit further comprising a single-to-differential buffer for generating a single input signal as a differential output signal.

3. The apparatus according to claim 1, further comprising a path control unit coupled between the transmission control unit, the reception control unit and the SERDES circuit configured to provide signals from the transmission control unit to the SERDES circuit, and provide signals from the SERDES circuit to the reception control unit.

4. The apparatus according to claim 1, wherein the SERDES circuit comprises:
a parallel/serial conversion unit configured to generate a serial signal from a plurality of parallel input signals outputted from the transmission control unit;
a pulse generation unit configured to generate a short pulse from the serial signal; and
a serial/parallel conversion unit configured to generate a plurality of parallel signals by separating the serial signal provided from the input/output buffer.

5. The apparatus according to claim 4, wherein the pulse generation unit generates a short pulse when the level of the serial signal outputted from the parallel/serial conversion unit is a logic high level.

6. The apparatus according to claim 4, wherein the pulse generation unit comprises:
a return to zero (RZ) signal generation unit configured to encode the serial signal to an RZ signal and output the encoded RZ signal; and
a short pulse generation unit configured to convert the output signal of the RZ signal generation unit into a short pulse.

7. The apparatus according to claim 6, wherein the RZ signal generation unit is configured to comprise a D-latch.

8. The apparatus according to claim 6, wherein the short pulse generation unit comprises:
a fixed delay unit configured to delay the output signal of the RZ signal generation unit by a first time;
a variable delay unit configured to delay the output signal of the RZ signal generation unit by a second time; and
a pulse output unit configured to generate the short pulse from output signals of the fixed delay unit and the variable delay unit.

9. A wireless signal transmitting/receiving apparatus for a semiconductor system, the apparatus comprising:
a SERDES circuit configured to output a parallel input signal as a serial signal, and output a serial input signal as a parallel signal; and
a coupling pad configured to inductively generate a wireless signal according to the serial signal outputted from the SERDES circuit, and provide a signal generated by inductive coupling with an external device as the serial input signal of the SERDES circuit.

10. The apparatus according to claim 9, wherein the SERDES circuit comprises:
a parallel/serial conversion unit configured to generate a serial signal from the parallel input signal;
a pulse generation unit configured to generate a short pulse from the serial signal; and
a serial/parallel conversion unit configured to generate the parallel signal from the serial signal.

11. The apparatus according to claim 10, wherein the pulse generation unit generates a short pulse when the level of the serial signal outputted from the parallel/serial conversion unit is a logic high level.

12. The apparatus according to claim 9, further comprising an input/output circuit configured to provide a separation signal obtained by separating the serial signal to the coupling pad, and provide a signal provided from the coupling pad to the SERDES circuit.

13. The apparatus according to claim 12, wherein the input/output circuit further comprising a single-to-differential buffer for generating a single input signal as a differential output signal.

14. A method of wirelessly transmitting a signal from a semiconductor system, comprising:
serializing a plurality of parallel configured signals to form a serial signal; and
coupling the serial signal to an inductive pad to wirelessly transmit the serial signal.

15. The method of claim 14, further including
shortening the serial signal to form a pulse signal, and
wherein coupling the serial signal includes coupling the pulse signal to the inductive pad.

16. The method of claim 15, wherein shortening the serial signal to form a pulse signal includes
providing a first fixed time delay to the serial signal to form a first fixed delayed signal;
providing a second fixed time delay to the serial signal to form a second fixed delayed signal; and
combining the first and the second fixed delayed signals to form the pulse signal.

17. The method of claim 14, further including converting the serial signal to a differential serial signal.

18. A method of receiving a wireless signal into a semiconductor system, comprising:
receiving the wireless signal at an inductive pad to form a series signal; and
converting the series signal to a plurality of parallel signals.

19. The method of claim 18, wherein the series signal is a differential series signal and further including converting the differential series signal to a non-differential series signal.
